(19) United States
(12) Patent Application Publication
(10) Pub. No.: US 2010/0123793 A1
(43) Pub. Date: May 20, 2010

(54) IMAGER FOR DETERMINING A MAIN SUBJECT

(75) Inventor: Yasuhiro Yamamoto, Tokyo (JP)

Correspondence Address: GREENBLUM & BERNSTEIN, P.L.C., 1950 ROLAND CLARKE PLACE, RESTON, VA, 20191, US

(73) Assignee: HOYA CORPORATION, Tokyo (JP)

(21) Appl. No.: 12/612,899

(22) Filed: Nov. 5, 2009

(30) Foreign Application Priority Data
Nov. 17, 2008 (JP) 2008-293204

(51) Int. Cl. H04N 9/73; H04N 5/228

(52) U.S. Cl. 348/223.1; 348/222.1; 348/E05.031; 348/E09.051

(57) ABSTRACT

An imager for capturing an image is provided having a face detector, a mouth detector, a sound detector, and a subject detector. The face detector detects a face in an image. The mouth detector detects the state of a mouth that is on the face detected by the face detector. The sound detector detects the ambient sound of the imager. The subject detector determines which face is the main subject on the basis of the state of its mouth at the time that the sound detector detects ambient sound.

### BACKGROUND OF THE INVENTION

1. Field of the Invention

The present invention relates to an imager that determines a main subject.

2. Description of the Related Art

A camera that can automatically focus on a subject is disclosed in Japanese Unexamined Patent Publication (KOKAI) No. 2006-208443. A camera comprises a face position detecting circuit, and automatically determines the position of a face on an image. An autofocus device focuses a photographing lens on the face.

However, in the case that multiple faces are included in an image, it is difficult for the autofocus device to automatically determine which particular face to focus on, therefore, the autofocus device may focus on a face that is not the main subject desired by a user.

### SUMMARY OF THE INVENTION

An object of the present invention is to provide an imager that can determine the main subject a user desires to focus on in the case where multiple subjects exist.

An imager for capturing an image is provided having a face detector, a mouth detector, a sound detector, and a subject detector. The face detector detects a face in an image. The mouth detector detects the state of a mouth that is on the face detected by the face detector. The sound detector detects the ambient sound of the imager. The subject detector determines which face is the main subject on the basis of the state of its mouth at the time that the sound detector detects ambient sound.

### BRIEF DESCRIPTION OF THE DRAWINGS

The objects and advantages of the present invention will be better understood from the following description, with reference to the accompanying drawings in which:

FIG. 1 is a perspective view of back of a digital camera having the imager according to the present invention;

FIG. 2 is a block diagram of the digital camera;

FIG. 3 is a flowchart of a main-subject detecting process; and

FIG. 4 is a schematic view of a display of the digital camera.

### DESCRIPTION OF THE PREFERRED EMBODIMENTS

The present invention is described below with reference to the embodiment shown in the drawings.

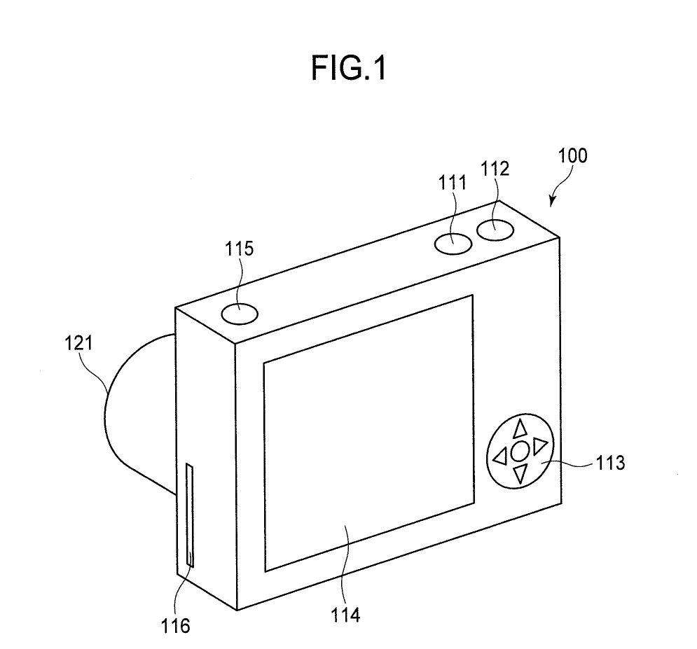

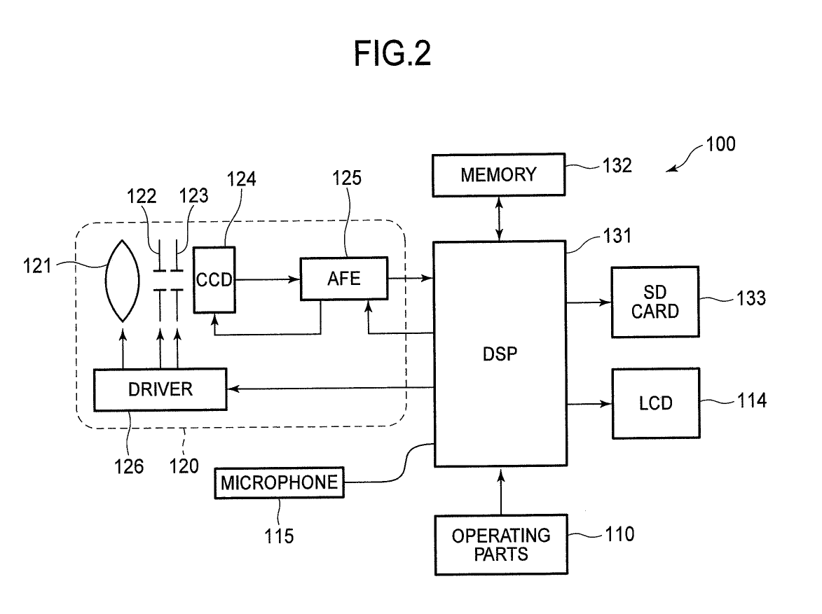

A digital camera 100, which is an imager according to the embodiment, is described with reference to FIGS. 1 to 4. The digital camera 100 is, for examples, a compact camera.

The digital camera 100 mainly comprises a DSP 131 that controls the digital camera 100, an operating part 110 that is used to operate the digital camera 100, a photographing member 120 that converts a subject image to a digital signal, a microphone 115 that converts an ambient sound outside of the digital camera 100 to an electrical signal, a memory 132 that stores data sent from the DSP 131, an SD card 133 that stores photographed images, and an LCD 114 that displays photographing conditions and photographed images.

The photographing member 120 mainly comprises a photographing lens 121, a shutter 123, an aperture 122, a CCD 124, an AFE (Analog Front End) 125, and a driver 126 that drives the photographing Lens 121, the shutter 123, and the aperture 122.

The driver 126 controls the position of the focusing system of the photographing lens 121 so that focus of the photographing lens 121 is adjusted to form a subject image on an imaging area of the CCD 124. The aperture 122 controls a beam of light running from the photographing lens 121 to the CCD 124 so as to control the amount of light a subject image forms on the imaging area. The shutter 123 controls the time periods in which a subject image is illuminated on the imaging area. The CCD 124 converts a subject image focused on the imaging area to an analog image signal and sends it to the AFE 125. The AFE 125 adjusts the gain and other aspects of the analog image signal, converts it to a digital image signal, then sends it to the DSP 131. The driver 126 controls the position of the focusing system, size of the aperture 122, and shutter speed according to signals received from the DSP 131.

The DSP 131 measures the amount of light of a subject, which is included in its digital image signal. The DSP 131 calculates an exposure value based on the amount of light, and calculates a shutter speed and an aperture value, i.e. an F-number, using the exposure value. After that, it sends the shutter speed and F-number to the driver 126. Moreover, it determines the appropriate position of the focusing system using the received digital image signal and sends the coordinates of the appropriate position of the focusing system to the driver 126. After the DSP 131 receives the digital image signal from the AFE 125, it adjusts white balance of the image before sending the adjusted image as a through image to the LCD 114. The through image consists of multiple still images, but is perceived as a moving image by a user.

During photographing, the DSP 131 processes the image of a digital image signal and creates a photographing image. The photographing image is stored in the SD card 133 and displayed on the LCD 114. The memory 132 is used as a working memory and stores data temporarily when the DSP 131 executes these calculations and carries out image processing.

The DSP 131 executes a face-detecting process. The face-detecting process detects the position and dimensions of a face included in the photographing image created from the digital image signal. The detected position and dimensions of a face are indicated in the through image using an indicating frame. The memory 132 stores the through image which is captured from a certain period before to the present time.

In the case where there is only one detected face, the DSP 131 focuses on the detected face, calculates its respective exposure value, and photographs it. After that, the DSP 131 adjusts the white balance of the photographed image while placing priority on the detected face, and then outputs the image data. Therefore, a photographing image is created such that its focus, exposure, and white balance are properly adjusted with respect to the detected face.

In the case where the face-detecting process detects more than one face, the DSP 131 executes the main-subject detecting process so that it selects only one face as a main subject among the multiple detected faces indicated, respectively, using indicating frames. Then, the DSP 131 creates a photographing image such that its focus, exposure, and white balance are properly adjusted with respect to the selected face. Note that a main subject is very likely to be the subject that is aimed at by the user.

The LCD 114 has a rectangular screen with an aspect ratio of 3 to 4, which is the same as a photographing image. The LCD 114 is provided on the central part of the back side of the digital camera 100, such that its longitudinal direction extends parallel to the longitudinal (left to right) direction of the digital camera 100 (See FIG. 1). Images captured through the photographing lens 121, photographed images, through images, and a variety of configuration data of the digital camera can be displayed on the LCD 114. The through image is sent from the DSP 131.

The operating parts 110 have a main power button 111, a release button 112, and a cross key 113.

The main power button 111 is a push switch projecting from the top of the digital camera 100. The digital camera 100 is powered when a user pushes the main power button 111. The digital camera 100 is powered off when a user pushes the main power button 111 while the digital camera 110 powered.

The release button 112 is a two-stage push switch that is provided on the top surface of the digital camera 100. The digital camera 100 executes photometry, distance surveying and focusing when a user depresses the release button 112 only half way. Otherwise, when the release button 112 is fully depressed, the digital camera 100 captures an image.

The cross key 113 is a rocker switch provided on the back of the digital camera 100. When a user depresses the cross key 113, the operating state of the digital camera 100 is set to the photographing mode so that the LCD 114 displays dialog for setting the photographing mode. A user operates the cross key 113 so as to select a desired photographing mode among multiple photographing modes.

The SD card 133 is detachably stored in a card slot 116 that is provided on the side of the digital camera 100. A user can access the SD card 133 and change it from the outside of the digital camera 100.

The microphone 115, which is provided on the top of the digital camera 100, converts ambient sound of the digital camera 100 to a digital sound signal, and sends it to the DSP 131.

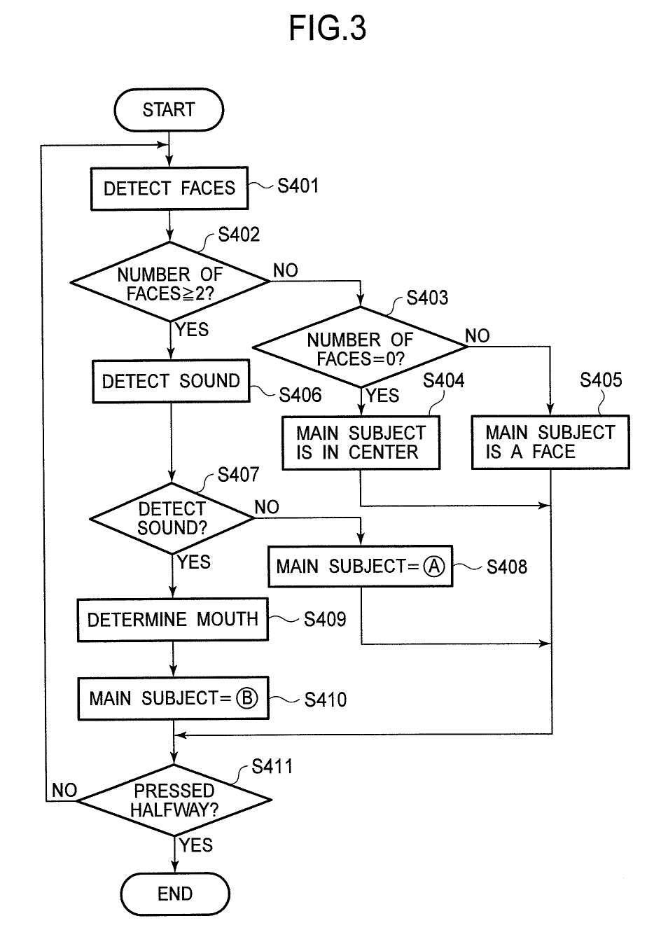

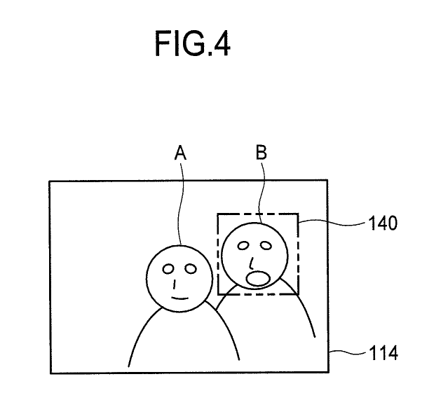

The main-subject detecting process is described hereinafter with reference to FIGS. 3 and 4.

In the case that the face-detecting process detects many faces, the DSP 131 must determine which face to calculate an exposure value for. Generally, in the case of photographing persons a photographer talks with the person who is to be the subject while photographing him/her. Therefore, the main-subject detecting process determines a main subject whose mouth is moving at the moment that a human voice is detected. The main-subject detecting process is executed by the DSP 131 at the moment when the through image is displayed on the LCD 114.

In Step S401, the face-detecting process is executed so that the position and dimensions of a face included in a through image are detected.

In Step S402, the number of detected faces is determined to be greater than or equal to two. In the case that it is greater than or equal to two, the processes of Step S406 and thereafter are executed for determining which face is the main subject. In the case that it is less than two, the process proceeds to Step S403.

In Step S403, the number of detected faces is determined to be zero. In the case that the number of detected faces is zero, i.e., no person is included in a through image, the process proceeds to Step S404. In the case that the number of detected faces is not zero, i.e., the number of detected faces is one, the process proceeds to Step S405.

In Step S404, an object existing at the center of a through image is determined to be a main subject because it is determined in Step S403 that no person is included in a through image.

In Step S405, the detected face is determined to be the main subject. Then, the process proceeds to Step S411.

In Step S406, ambient sound is input to the DSP 131 from the microphone 115. In Step S407, it is determined that a human voice is detected from the ambient sound input during a certain period. This is accomplished by determining that sound in the 1-4 kHz range exceeds a threshold value. In the case that a human voice is not detected, the process proceeds to Step S408. In the case that a human voice is detected, the process proceeds to Step S409.

In Step S408, the face A that exists at the center of a through image is determined to be a main subject. Then, the process proceeds to Step S411.

In Step S409, a mouth determining process is executed. The mouth determining process detects a mouth on a detected face and determines whether the mouth is open or not. This determination is made by comparing the image of a mouth that is photographed at the moment of detecting a human voice in Step S407 with the image of a mouth that is photographed slightly before the moment of detecting a human voice. In the case that the area of the mouth image is larger than the one slightly before, it is determined that the mouth is open. Then, the process proceeds to Step S410.

In Step S410, the face B having the opened mouth is determined to be the main subject. Then, the indicating frame 140 is displayed around the face B, i.e., the main subject. After that, the process proceeds to Step S411.

According to Steps S406 to S410, a subject whose mouth opens at the moment that a human voice is detected is determined as to be the main subject.

In Step S411, it is determined whether the release button 112 is depressed halfway or not. In the case that the release button 112 is depressed halfway, the process ends. In the case that the release button 112 is not depressed halfway, the process proceeds to Step S401.

After that, the DSP 131 focuses on the main subject, calculates an exposure value with respect to it, calculates a shutter speed and aperture value, i.e., an F-number using the exposure value, and then takes a photograph. After that, the DSP 131 adjusts the white balance of a photographed image by placing priority on the detected face, then outputs the image data.

According to the embodiment, the imager can determine a main subject as the subject that is desired by the user to be the main subject, in the case that multiple subjects exist.

Note that, the digital camera 100 may not display a through image on the LCD 114, may display an indicating frame on a finder, and may execute the main-subject detecting process when the indicating frame is displayed.

Note that, in the mouth determining process, the determination is executed by comparing color difference information of a mouth image that is photographed at the moment of detecting a human voice in Step S407 with color difference information of a mouth image photographed slightly before the moment of detecting the human voice. A subject having color difference information that is smaller than a certain value is determined as the main subject. Brightness of a mouth image may be higher because teeth appear when a person opens his/her mouth. Therefore, an open mouth may be detected by higher brightness of a mouth image. A subject having brightness that is greater than a certain value is determined as the main subject.

Note that, in the case that multiple faces are detected in Step S402, the main subject is selected in consideration of the distance from the subject to the center of the through image or the distance from the subject to the digital camera 100 in Step S409.

Note that, in Steps S407, S409, and 410, the person who produces a largest voice may be selected as the main subject. In Steps S407, S409, and 410, when a person produces a voice before a user of the digital camera 100 produces a voice, the person producing a voice may be selected as the main subject.

Note that, the mouth detecting process may be executed by comparing an aspect ratio of a mouth image that is photographed at the moment of detecting a human voice in Step S407 with the aspect ratio of a mouth image photographed slightly before the moment of detecting a human voice. In the case that an aspect ratio of a mouth image changes, it is determined that the mouth opens.

One or more of white balance, aperture value and shutter speed may be adjusted or calculated with respect to the main subject.

Although the embodiment of the present invention has been described herein with reference to the accompanying drawings, obviously many modifications and changes may be made by those skilled in the art without departing from the scope of the invention.

The present disclosure relates to subject matter contained in Japanese Patent Application No. 2008-293204 (filed on Nov. 17, 2008), which is expressly incorporated herein, by reference, in its entirety.

1. An imager for capturing an image comprising:
a face detector that detects a face in an image;
a mouth detector that detects the state of a mouth that is on the face detected by said face detector;
a sound detector that detects the ambient sound of said imager; and
a subject detector that determines which face is the main subject on the basis of the state of its mouth at the time that said sound detector detects ambient sound.

2. The imager according to claim 1, wherein said subject detector determines which face is the main subject on the basis of whether its mouth is open.

3. The imager according to claim 1, wherein said subject detector determines which face is the main subject on the basis of whether an aspect of its mouth is larger than a certain value.

4. The imager according to claim 1, wherein said subject detector determines which face is the main subject on the basis of whether a change in the state of its mouth is larger than a certain value.

5. The imager according to claim 1, wherein said subject detector determines which face is the main subject on the basis of whether the brightness of its mouth is greater than a certain value.

6. The imager according to claim 1, wherein said subject detector determines which face is the main subject on the basis of whether color difference information related to its mouth is smaller than a certain value.

7. The imager according to claim 1, further comprising an auto-focusing part that focuses a photographing lens onto a subject, and said auto-focusing part focusing the photographing lens onto the face that is determined to be the main subject by said subject detector.

8. The imager according to claim 1, further comprising an auto-exposure part that determines an exposure value for a subject, and said auto-exposure part determining an exposure for a face that is determined to be the main subject by said subject detector.

9. The imager according to claim 1, further comprising an AWB part that determines a white balance value for a subject, and said AWB part determining a white balance value for a face that is determined to be the main subject by said subject detector.
